(19) United States
(12) Patent Application Publication
(10) Pub. No.: US 2005/0066218 A1
(43) Pub. Date: Mar. 24, 2005

(54) Method and apparatus for alert failover

(76) Inventors: Thomas L. Stachura, Austin, TX (US); Parthasarathy Sarangam, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/671,124

(22) Filed: Sep. 24, 2003

(51) Int. Cl. G06F 11/00

(52) U.S. Cl. 714/3

(57) ABSTRACT

A method and apparatus for an alert system are described.

### BACKGROUND

The term “system manageability” may refer to techniques directed to remotely managing and controlling a system, such as a computer or server. One aspect of system manageability may include alerting techniques. An alerting system may provide advance warning and system failure indication from managed clients to remote management consoles. The alerting system may monitor one or more sensors positioned in the managed client, such as a computer on a network. If a problem is detected via the sensors, the alerting system may send an alert to the remote management console. From there, the problem may be addressed by the appropriate personnel. Consequently, an alerting system may reduce demands on limited service personnel, while increasing system availability and reliability. Accordingly, there may be need for improvements in system manageability techniques.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates an Alert Standard Format (ASF) system suitable for practicing one embodiment;

FIG. 2 illustrates a block diagram of a network node having a plurality of Alert Sending Devices (ASD) in accordance with one embodiment; and

FIG. 3 illustrates a block diagram of an ASD in accordance with one embodiment;

FIG. 4 is a first block flow diagram of the programming logic performed by an ASD in accordance with one embodiment; and

FIG. 5 is a second block flow diagram of the programming logic performed by an ASD in accordance with one embodiment.

### DETAILED DESCRIPTION

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

The embodiments may be implemented using an architecture that may vary in accordance with any number of factors, such as desired computational rate, power levels, heat tolerances, processing cycle budget, input data rates, output data rates, memory resources, data bus speeds and other performance constraints. For example, one embodiment may be implemented using software executed by a processor. The processor may be a general-purpose or dedicated processor, such as a processor made by Intel® Corporation, for example. The software may comprise computer program code segments, programming logic, instructions or data. The software may be stored on a medium accessible by a machine, computer or other processing system. Examples of acceptable mediums may include computer-readable mediums such as read-only memory (ROM), random-access memory (RAM), Programmable ROM (PROM), Erasable PROM (EPROM), magnetic disk, optical disk, and so forth. In one embodiment, the medium may store programming instructions in a compressed and/or encrypted format, as well as instructions that may have to be compiled or installed by an installer before being executed by the processor. In another example, one embodiment may be implemented as dedicated hardware, such as an Application Specific Integrated Circuit (ASIC), Programmable Logic Device (PLD) or Digital Signal Processor (DSP) and accompanying hardware structures. In yet another example, one embodiment may be implemented by any combination of programmed general-purpose computer components and custom hardware components. The embodiments are not limited in this context.

The embodiments may comprise one or more modules. Although the embodiment has been described in terms of “modules” to facilitate description, one or more circuits, components, registers, processors, software subroutines, or any combination thereof could be substituted for one, several, or all of the modules.

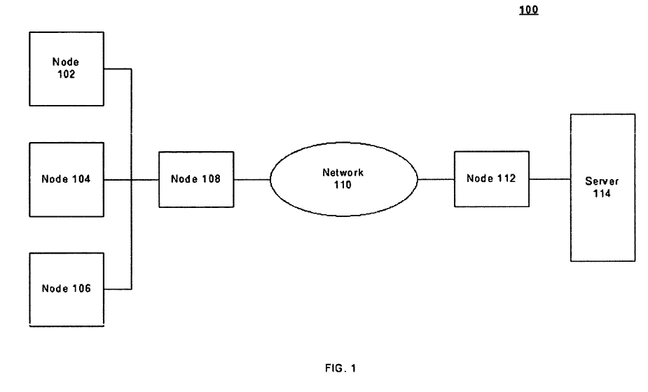

Referring now in detail to the drawings wherein like parts are designated by like reference numerals throughout, there is illustrated in FIG. 1 a system suitable for practicing one embodiment. FIG. 1 is a block diagram of a system 100. System 100 may illustrate a system suitable for implementing system manageability techniques, such as an alerting system. An alerting system may comprise one or more client systems and a remote management console. The remote management console may monitor and control the client systems.

The alert system may be configured to operate in accordance with any number of standards. The type of standard may depend in part upon the operating environment of the managed client. In one embodiment, for example, the alert system may be configured to operate in an environment where the Operating System (OS) is not present, such as in accordance with the Alert Standard Format (ASF) Specification, as defined by the Distributed Management Task Force (DMTF), Version 1.3, dated Jun. 20, 2001, and Version 2.0, dated Jun. 24, 2003 (collectively referred to as the “ASF Specification”). The alert system, however, may also be configured to operate in an environment where the managed client is fully operational in its OS-present environment, such as in accordance with the Desktop Management Interface (DMI) and Common Information Model (CIM) interfaces as defined by DMTF. The embodiments are not limited in this context.

In one embodiment, an ASF-aware client may provide several interfaces to allow interoperability between the client and its management console. For example, a first interface may be for alert messages transmitted by the client system. A second interface may be for remote maintenance requests sent to the client system and the associated responses. A third interface may be for the data description of the client's system-specific capabilities and characteristics. A fourth interface may be for the software used to configure or control the client system in an OS-present state. The number and types of interfaces used for the ASF system is not limited in this context.

In an ASF system, an additional level of interoperability may also occur between a client system's alerting components. For example, one level of interoperability may be directed to the system firmware techniques used to communicate system capabilities to an alert-capable add-in card's OS-present configuration software. A second level of interoperability may be for the format of the messages sent between the add-in card, the local system host, and local system sensors.

Referring again to FIG. 1, system 100 may comprise a plurality of network nodes. The term “network node” as used herein may refer to any node capable of communicating information in accordance with one or more protocols. Examples of network nodes may include a computer, server, switch, router, bridge, gateway, personal digital assistant, mobile device, call terminal, modem and so forth. The term “protocol” as used herein may refer to a set of instructions to control how the information is communicated over the communications medium.

In one embodiment, system 100 may communicate various types of information between the various network nodes. For example, one type of information may comprise “control information.” Control information may refer to any data representing commands, instructions or control words meant for an automated system. For example, control information may be used to route media information through a network, or instruct a network node to process the media information in a predetermined manner.

In one embodiment, one or more communications mediums may connect the nodes. The term “communications medium” as used herein may refer to any medium capable of carrying information signals. Examples of communications mediums may include metal leads, semiconductor material, twisted-pair wire, co-axial cable, fiber optic, radio frequencies (RF) and so forth. The terms “connection” or “interconnection,” and variations thereof, in this context may refer to physical connections and/or logical connections.

In one embodiment, system 100 may comprise network nodes 102, 104, 106, 108 and 112. Nodes 108 and 112 may be connected by a network 110. Node 112 may be connected to a server 114. Although FIG. 1 shows a limited number of network nodes, it can be appreciated that any number of network nodes may be used in system 100.

In one embodiment, all the elements of system 100 may be connected by one or more communications mediums as desired for a particular implementation. For example, the communications mediums may comprise RF spectrum for a wireless network, such as a cellular or mobile system. In this case, the network nodes and/or networks shown in system 100 may further comprise the devices and interfaces to convert the packet signals carried from a wired communications medium to RF signals. Examples of such devices and interfaces may include omni-directional antennas and wireless RF transceivers. The embodiments are not limited in this context.

In one embodiment, system 100 may comprise network nodes 102, 104 and 106. Network nodes 102, 104 and 106 may represent managed clients for an alert system. An example of network nodes 102, 104 and 106 may include a processing system, such as a computer, server or workstation. Each network node may include a network interface to communicate with other network nodes. The network nodes may each be configured with one or more Alert Sending Devices (ASD) and sensors. The ASD may be used to monitor the sensors. If an ASD detects a problem with a sensor, it may generate an alert message and communicate the alert message to server 114. The ASD may be configured to operate in environments with or without an OS, as discussed previously. An example of the latter may be desirable if the OS for a system does not properly “boot” or initialize the system as expected.

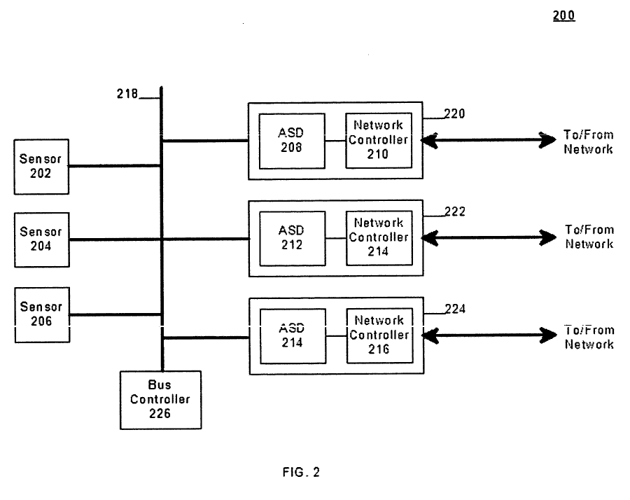

In one embodiment, system 100 may comprise network nodes 108 and 112. Network nodes 108 and 112 may represent, for example, routers for system 100. The routers may assist in routing information through system 100 from network nodes 102, 104 and 106 to server 114 via network 110, for example. As with network nodes 102, 104 and 106, routers 108 and 112 may also be configured with an ASD and sensors. Since the performance of routers 108 and 112 may have a potentially greater impact on system 100 then other network nodes in terms of overall system performance, it may be of even greater importance to monitor and remotely manage routers 108 and 112 to ensure proper performance. Consequently, routers 108 and 112 may be implemented with multiple sets of ASDs and multiple sensors to ensure redundancy and increased availability. The ASD and sensors in general, and as implemented as part of multiple ASD systems, may be discussed in more detail with reference to FIG. 2.

In one embodiment, system 100 may comprise network 110. Network 110 may represent a packet network, such as a Local Area Network (LAN) or Wide Area Network (WAN). The network nodes of system 100 may communicate information to server 114 via network 110. In one embodiment, the protocols may be lightweight, bit-based information carriers such as the Simple Network Management Protocol (SNMP) or User Datagram Protocol (UDP), since many ASF implementations are hardware and/or firmware based. In another embodiment, the network nodes of system 100 may communicate information to server 114 in the form of packets via network 110. A packet in this context may refer to a set of information of a limited length, with the length typically represented in terms of bits or bytes. An example of a packet length might be 1000 bytes. The packets may be communicated in accordance with one or more packet protocols. For example, in one embodiment the packet protocols may include one or more Internet protocols, such as the Transmission Control Protocol (TCP) and Internet Protocol (IP). The embodiments are not limited in this context.

In one embodiment, system 100 may comprise a server 114. Server 114 may represent, for example, a remote management console. The remote management console may be a processing system, such as a server, having a processor, memory and network interface. The remote management console may be configured with the appropriate hardware and/or software to implement various system manageability techniques as desired for a particular implementation. For example, the remote management console may be used to configure and manage each ASD implemented as part of network nodes 102, 104 and 106. Further, the remote management console may receive alert messages from an ASD, and respond as appropriate. For example, the remote management console may identify the problem and display relevant information to assist in the diagnosis and resolution of the problem. The remote management console or a human operator may attempt to solve the problem using remote management techniques, or sending the appropriate service personnel on site to correct the problem. The embodiments are not limited in this context.

In one embodiment, the client system and remote management console may communicate information between each other in accordance with a number of communication protocols. For example, the client system and remote management console may communicate information between each other in accordance with the Platform Event Trap (PET) protocol, SNMP, UDP, Remote Management Control Protocol (RMCP), and so forth. The embodiments are not limited in this context.

In one embodiment, the ASD may be implemented using a network controller. The network controller may be implemented as part of any number of components, such as a Network Interface Card (NIC) such as an Ethernet NIC, Local Area Network (LAN) on Motherboard (LOM), and so forth. The embodiments are not limited in this context.

In general operation, an ASF capable managed client such as network nodes 102, 104 and/or 106, or routers 108 and 112, may have an ASD added to monitor one or more sensors. When the ASD is added, the ASD should be configured with the client's specific hardware configuration before it can properly issue alerts and respond to remote maintenance requests. To accomplish this, the client system requires one good boot to an OS-present environment to allow the device's configuration software to run and store system-specific information into the device's non-volatile storage. In an Advanced Configuration and Power Interface (ACPI) aware OS-present environment, for example, the alert-sending device's configuration software may interrogate the client's configuration data to retrieve information required for any alert messages to be sent, and stores that information into the device's non-volatile storage for use in the OS-absent environment. The information may comprise, for example, the client's ASF capabilities, including the Internet Assigned Numbers Authority (IANA) Manufacturer Identifier (ID) and System ID, the client's System Management Basic Input/Output System (SMBIOS) structure-table containing the system Globally Unique Identifier (GUID) or Universal Unique Identifier (UUID), the TCP/IP address assigned to the ASD by the OS, a wait time for the ASD prior to issuing a system boot-failure alert, and so forth. The configuration software also provides an interface to allow the system owner to identify the TCP/IP address of the management console to which any alert messages are to be sent by the managed client.

During this OS-present configuration process, the managed client's optional ASF configuration may also be determined and stored in the alert-sending device's non-volatile storage. For example, ASF configuration information such as the addressing and configuration information for each legacy sensor may be retrieved. In another example, ASF configuration information such as which ASF defined features are supported for remote-control operations may also be retrieved. Once the system owner has configured the alert-sending device, the managed client is enabled to send alert messages and, optionally, respond to remote-control requests from a specified management console.

One problem associated with an ASD configured to operate in an ASF environment is the reliance upon a single ASD and single network interface to monitor a system. This may be particularly problematic for high availability systems, which may be those systems that are intolerant of system downtime or of particularly critical importance to overall system or network operations. As illustrated with reference to FIG. 1, it may be desirable for routers 108 and 112 of system 100 to have a higher level of system manageability, as discussed in more detail with reference to FIG. 2. Although one embodiment may be described with reference to routers 108 and 112, it may be appreciated that the principles discussed herein may be applicable to any network node configured with multiple ASD and/or network interfaces.

FIG. 2 illustrates a block diagram of a network node having a plurality of ASDs and network interfaces in accordance with one embodiment. FIG. 2 illustrates a system 200. System 200 may represent any ASF system having multiple ASDs and multiple network interfaces, such as routers 108 and 112, for example. In one embodiment, system 200 may comprise sensors 202, 204 and 206. System 200 may further comprise NICs 220, 222 and 224. Each NIC in turn may comprise at least one ASD and network controller. The sensors and ASDs may communicate with each other via a System Management Bus (SMBus) 218. Use of the SMBus may be managed by a SMBus controller 226. The ASDs may communicate with a remote management console, such as server 114, for example. This communication may occur via a network, such as network 110, for example. Although system 200 illustrates a limited number of sensors, ASDs and network interfaces for purposes of clarity, it may be appreciated that any number of these components may be used and still fall within the scope of the embodiments.

In one embodiment, system 200 may comprise a plurality of NICs. For example, system 200 may comprise NIC 220, NIC 222 and NIC 224. NIC 220 may further comprise an ASD 208 and network controller 210. NIC 222 may further comprise an ASD 212 and network controller 214. NIC 224 may further comprise an ASD 214 and network controller 216.

In one embodiment, each ASD may comprise an ASD in accordance with the ASF Specification and modified using the principles discussed herein. More particularly, ASD 208, 212 and 214 may operate together to monitor one or more sensors, such as sensors 202, 204 and 206. If a problem is detected with a sensor, the detecting ASD may communicate an alert message to a remote management console, such as server 114. The remote management console may then attempt to correct the identified problem using any number of remote management techniques, such as restarting the system, for example. The embodiments are not limited in this context.

In one embodiment, each NIC may include a network controller, such as network controllers 210, 214 and 216. The network controller may comprise a network adapter or network interface configured to operate with any suitable technique for controlling communication signals between computer or network devices using a desired set of communications protocols, services and operating procedures, for example. In one embodiment, the network controllers may operate, for example, in accordance with the ASF Specification, although the embodiments are not limited in this context. The network controllers may also include the appropriate connectors for connecting the network controllers with a suitable communications medium.

In one embodiment, ASD 208, 212 and 214 may communicate with sensors 202, 204 and 206 via SMBus 218 and SMBus controller 226. An example of SMBus 218 and SMBus controller 226 may comprise these elements operating in accordance with the document titled “System Management Bus Version 2.0,” as defined by the SMBus Specification Working Group (SSWG), and dated Jun. 20, 2001 (“SMBus Specification”).

In one embodiment, SMBus 218 is a two-wire interface through which various system component chips can communicate with each other and with the rest of the system. SMBus 218 may operate as a control bus for system and power management related tasks. A system may use SMBus 218 to pass messages between devices instead of tripping individual control lines. Removing the need for individual control lines may reduce pin count. Accepting messages may ensure future expandability. Using SMBus 218, a device can perform a number of different functions, such as provide information about itself such as manufacturer information or model/part number, save its state for a suspend event, report different types of errors, accept control parameters, return its status, and so forth.

In one embodiment, system 200 may also comprise sensors 202, 204 and 206. The sensors of system 200 may be used to monitor different components or characteristics of a system. For example, a sensor may be used to measure temperature, voltage levels, hard drive failure, hardware failure, software failure, and so forth. The embodiments are not limited in this context. In one embodiment, the sensors may be ASF compatible sensors or legacy sensors, as defined by the ASF Specification. The type of sensor is not limited in this context, as long as it may be suitable for monitoring by an ASD.

As shown in FIG. 2, multiple ASDs may be monitoring one or more sensors over a single bus, such as SMBus 218, for example. Each ASD may not necessarily be monitoring the same sensor. Rather, each ASD may be monitoring a separate set of sensors to increase system efficiency. In this configuration, a problem may occur if an ASD for a given set of sensors fails or becomes non-operational. A similar problem may occur if the network interface associated with a particular ASD fails or becomes non-operational. In either of these cases, the ASD may be unable to communicate an alert message to the remote management console if it detects a failure condition of one of the sensors. This may significantly affect performance of the overall alerting system.

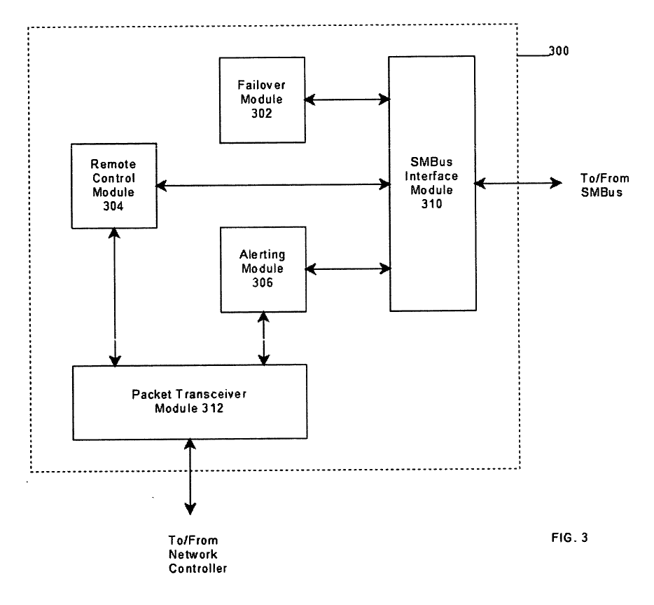

One embodiment attempts to solve this and other problems by introducing redundancy into the ASF system. This may occur by configuring the ASDs to communicate with each other via SMBus 218. In this manner, if an ASD has a failure condition, another ASD may takeover operations on behalf of the failed ASD. Accordingly, system disruptions may be reduced, and the alarm system may realize increased system performance. The redundancy aspect of system 200 may be discussed in more detail with reference to FIG. 3.

FIG. 3 illustrates a block diagram of an ASD in accordance with one embodiment. FIG. 3 illustrates an ASD 300. ASD 300 may be representative of, for example, ASD 208, 212 and 214. As shown in FIG. 3, ASD 300 may comprise a failover module 302, a remote control module 304, an alerting module 306, an SMBus interface module 310, and a packet transceiver module 312.

In one embodiment, SMBus interface module 310 may communicate messages between components of ASD 300 and other components connected to SMBus 218. For example, ASD 300 may communicate with sensors 202, 204 and 206 via SMBus 218. In another example, ASD 300 may communicate with other ASDs connected to SMBus 218. In another example, ASD 300 may communicate with the host controller for the system or NIC, a chipset on the motherboard of the host system, various drivers (e.g., sensor, alerting, NIC) stored in the host system, system firmware or BIOS stored in the NIC or host system, other local add-in cards connected to the mother board, and any other components connected to SMBus 218. The embodiments are not limited in this context.

In one embodiment, remote control module 304 may be used to implement remote control or management functions for ASD 300. For example, once a problem has been detected an alert may be sent to the remote management console. The remote management console or a user may take control of the host system implementing ASD 300 in an attempt to correct the problem. For example, the remote management console may issue a command to remote control module 304 to power down and restart the host system.

In one embodiment, alerting module 306 may monitor one or more of sensors 202, 204 and 206. As described previously, alerting module 306 may poll each sensor for a change in status. Location of the sensor and information about how to interpret and respond to the data may be programmed into alerting module 306 of ASD 300 by configuration software at the initial configuration time. Once a change of status has been detected, alerting module 306 may generate an alert message for delivery to the remote management console via its network controller. The alert message may comprise one or more predefined codes indicating which sensor has a change in status and possible problems, for example.

In one embodiment, packet transceiver module 312 may perform packet processing for information received by ASD 300. For example, the host system of ASD 300 may implement a layered stack of protocols (“protocol stack”), with each protocol requiring different processing instructions. Packet transceiver module 312 may receive the alert message from alerting module 306, process the data in accordance with the protocol stack, and send the appropriate data to the network controller. Similarly, packet transceiver module 312 may receive packets of information from the network controller, remove the appropriate control information for ASD 300, and forward the control information to the appropriate module for action.

In one embodiment, failover module 302 may implement the redundancy features for an ASF system, such as ASF system 200. Failover module 302 may comprise programming logic to execute failover techniques in the event ASD 300, or another ASD, has a change of state. For example, ASD 300 may have an operating state and a failed state. The operating state may indicate that ASD 300 is operating according to normal parameters. A failed state may indicate that ASD 300 is operating outside of normal parameters. Examples of a failed state may include an unintentional loss of power, an intentional loss of power for maintenance or upgrades, a corruption of hardware or software components of ASD 300, and so forth. The embodiments are not limited in this context.

In one embodiment, multiple ASDs may be monitoring multiple sensors using the same SMBus. The multiple ASDs may be organized into teams, with each team member being configured to operate in a primary mode or a secondary mode. An ASD configured to operate in the primary mode (“primary ASD”) may monitor some or all of the sensors. The remaining ASDs may be configured to operate in the secondary mode (“secondary ASD”) and may monitor a different set of sensors, or just the primary ASD.

Each ASD may be configured to operate in a primary mode or secondary mode in a number of different ways. For example, an ASD may be configured by a remote management console, from the host via a user interface or configuration file, non-volatile storage storing the previous configuration for an ASD, and so forth. The embodiments are not limited in this context.

In operation, the primary ASD may periodically send a status message over the SMBus. The secondary ASDs may monitor the SMBus for the status message. Depending on the contents of the status message, or failure to receive a status message within a predetermined time period, one of the secondary ASDs may be automatically configured to switch from the secondary mode to the primary mode, and take over the monitoring operations performed by the previous primary ASD. This may be repeated if the new primary ASD also enters into a failed state, until there are no ASDs remaining in operation.

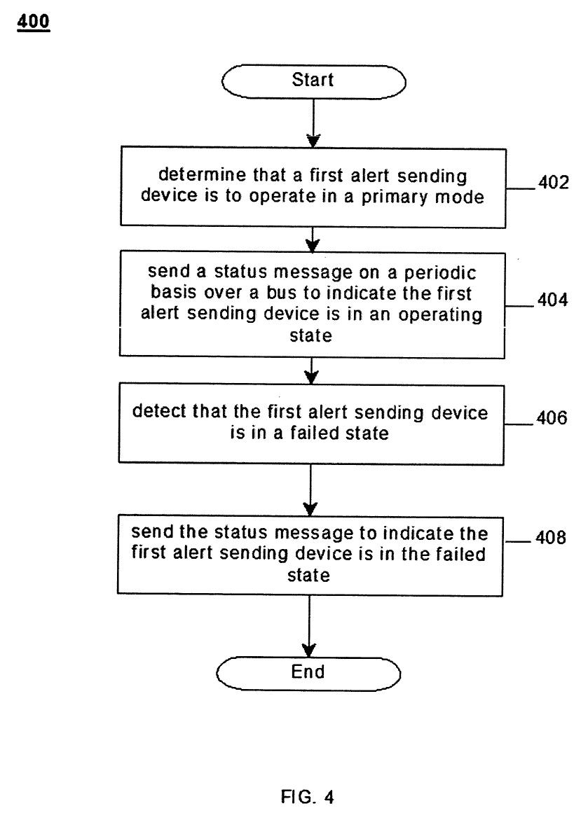

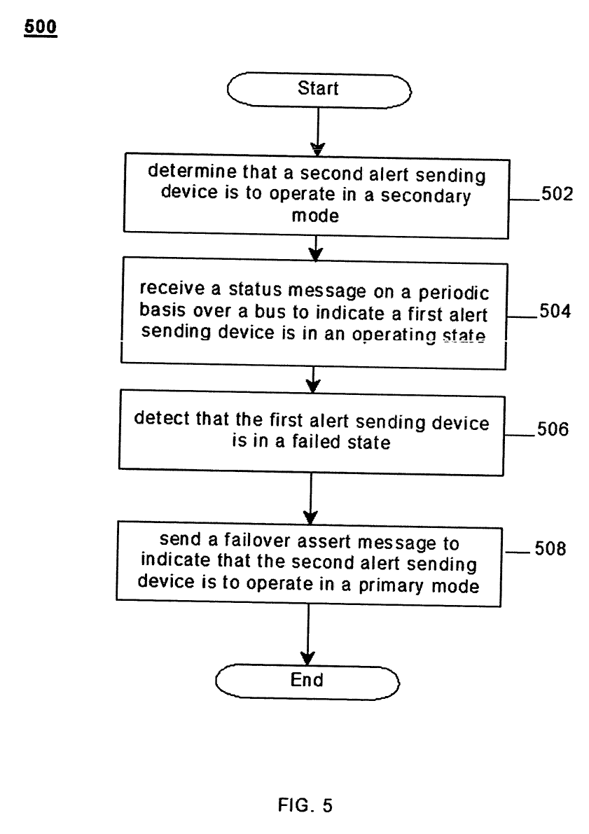

The operations of systems 100, 200 and 300 may be further described with reference to FIGS. 4 and 5 and accompanying examples. Although FIGS. 4 and 5 as presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 4 is a first block flow diagram of the programming logic performed by an ASD in accordance with one embodiment. FIG. 4 illustrates a programming logic 400. Programming logic 400 may operate to perform failover for an ASF system, such as ASF system 200. In one embodiment, a determination is made that a first alert sending device is to operate in a primary mode at block 402. The first alert sending device may be, for example, monitoring one or more sensors. A status message may be sent on a periodic basis over a bus to indicate the first alert sending device is in an operating state at block 404. It may be detected that the first alert sending device is in a failed state at block 406. A status message may be sent to indicate that the first alert sending device is in the failed state at block 408.

A status message may be sent on a periodic basis over a bus to indicate the first alert sending device is in an operating state at block 404. The status message may comprise fields having data representing a teamed address, a failover status and an alert sending device address for the first alert sending device.

In one embodiment, a determination may be made that the first alert sending device is to operate in a primary mode at block 402. The first alert sending device may be configured to operate in a primary mode by receiving a configuration message from the remote management console, for example. The configuration message may comprise fields having data representing an alert sending device address for the first alert sending device, a failover configuration, and a teamed address.

FIG. 5 is a second block flow diagram of the programming logic performed by an ASD in accordance with one embodiment. FIG. 5 illustrates a programming logic 500. Programming logic 500 may operate to perform failover for an ASF system, such as ASF system 200. In one embodiment, a determination may be made that a second alert sending device is to operate in a secondary mode at block 502. A status message may be received on a periodic basis over a bus to indicate a first alert sending device is in an operating state at block 504. It may be detected that the first alert sending device is in a failed state at block 506. A failover assert message may be sent to indicate that the second alert sending device is to operate in a primary mode at block 508.

In one embodiment, it may be detected that the first alert sending device is in a failed state in several ways. For example, the detection may occur by receiving the status message. A failover status identifier may be retrieved from the status message. The detection that the first alert sending device is in a failed state may be made in accordance with the failover status identifier.

In one embodiment, the detection may occur by monitoring the bus for the given period. A determination may be made as to whether the status message was received within the period. The detection that the first alert sending device is in the failed state may be made if the status message is not received within the period.

In one embodiment, a determination may be made that a second alert sending device is to operate in a secondary mode at block 502. The second alert sending device may be configured to operate in a secondary mode by receiving a configuration message from the remote management console, for example. The configuration message may comprise fields having data representing an alert sending device address for the first alert sending device, a failover configuration, and a teamed address.

In one embodiment, a failover assert message may be sent to indicate that the second alert sending device is to operate in a primary mode at block 508. The failover assert message may comprise fields having data representing a teamed address and an alert sending device address for the second alert sending device.

The operation of systems 100, 200 and 300, and the programming logic shown in FIGS. 4 and 5, may be better understood by way of example. Assume an ASF system 200 comprises sensors 202, 204 and 206. The ASDs may be configured to operate as a team, with one member of the team designated as a primary ASD to monitor sensors 202, 204 and 206, and the other members of the team designated as secondary ASDs to monitor the primary ASD. In this example, assume that ASD 208 is configured to operate in primary mode, and ASDs 212 and 214 are both configured to operate in secondary mode. Although only three ASDs are described in this example, it can be appreciated that the same principles apply to any number of ASDs in accordance with a given implementation.

During the configuration process, a user may determine that ASD 208 should be initially configured to operate in a primary mode. A remote management console, such as server 114, for example, may send a configuration message to ASD 208 via SMBus 218. An example of a configuration message may be a failover command as follows:
ASD_FAILOVER_SETUP (asd_address, failover_config, teamed_address).
   The asd_address field may represent the SMBus address of the target ASD. The failover_config field may represent one of three arguments {no_failover, primary, secondary}. The first argument no_failover may indicate that the ASD is not to implement any failover techniques. The second argument primary may indicate that the ASD is to operate in a primary mode. The third argument secondary may indicate that the ASD is to operate in a secondary mode. The teamed_address field may represent the SMBus address of the original ASD configured in the primary mode for the failover team.

The ASD_FAILOVER-SETUP command may be issued by the SMBus host controller under software direction to configure an ASD for the proper failover operation. An ASD may be configured for no failover, or failover such that the device is the primary or secondary ASD. In normal operation, there is typically only one primary and at least one secondary, although the embodiments are not limited in this context.

In this example, assume failover module 302 of ASD 208 receives a configuration message indicating that it is to operate in the primary mode. While operating in primary mode, failover module 302 of ASD 208 may send a status message indicating the current status of ASD 208 on a periodic basis. An example of a status message may be failover command as follows:
ASD_FAILOVER_HEARTBEAT (teamed_address, failover status, asd_address)
   The teamed_address field may represent the SMBus address of the original ASD configured in the primary mode for the failover team. The failover_status field may represent the status of the primary ASD, such as in an operational state or a failed state, for example. The asd_address field may represent the SMBus address of the ASD mastering this transaction, e.g., the primary ASD.

The ASD_FAILOVER_HEARTBEAT command may be issued by any ASD configured to operate in the primary mode. This command is typically issued on a well-known periodic cycle. Through this command, the primary ASD may indicate whether it is in an operational state or a failed state. It also may identify itself with its own assigned SMBus address.

In this example, assume ASD 208 begins sending the status message on a periodic basis over SMBus 218. Secondary ASDs 212 and 214 may monitor ASD 208 to detect whether it has a change of state, e.g., enters into a failed state. The detection may be accomplished in a number of ways. For example, if ASD 208 detects that it is beginning to fail, it may issue a status message indicating a failed state. Secondary ASDs 212 and 214 may receive the status message, and begin the process of taking over operations for the failing primary ASD. Alternatively, secondary ASDs 212 and 214 may monitor SMBus 218 for the predetermined period of time. If a status message is not received within the time period, then it may be assumed that the primary ASD 208 has entered a failed state, and secondary ASDs 212 and 214 may begin the takeover operations.

Once secondary ASD 212 and 214 detect that primary ASD 208 has entered into a failed state, they may contend to become the new primary ASD. This may be accomplished using the failover command as follows:
ASD_FAILOVER_ASSERT (teamed_address, asd_address)
   The teamed_address field may represent the SMBus address of the original ASD configured in the primary mode for the failover team. The field asd_address may represent the SMBus address of the secondary ASD mastering this transaction, e.g., the secondary ASD taking over as primary ASD.

The ASD_FAILOVER_ASSERT command may be issued by a secondary ASD that wants to become a primary. A secondary ASD may issue this command if it has not seen a status message from the original primary ASD in a specified time-out period or if the original primary has indicated via the status message that it is in a failed state. All secondary ASDs in the team monitor this transaction. The secondary ASD successfully mastering this cycle changes its state to primary mode and becomes the new primary ASD. All other ASDs in the team operate in secondary mode and reset their time-out monitoring period.

The operation of the failover techniques described in this example may be summarized in Table 1.

TABLE 1

| Host | | | | | | |
|---|---|---|---|---|---|---|
| Controller | ASD A | | ASD B | | ASD C | |
| Action | State | Action | State | Action | State | Action |
| — | No_failover | Reset | No_failover | Reset | No_failover | Reset |
| setup(A, pri, A) | Primary | — | No_failover | — | No_failover | — |
| setup(B, sec, A) | Primary | — | Secondary | — | No_failover | — |
| setup(C, sec, A) | Primary | — | Secondary | — | Secondary | — |
| — | Primary | — | Secondary | — | Secondary | — |
| — | Primary | Hb(A, ok, A) | Secondary | — | Secondary | — |
| — | Primary | — | Secondary | — | Secondary | — |
| — | Primary | Hb(A, ok, A) | Secondary | — | Secondary | — |
| — | Primary | — | Secondary | — | Secondary | — |
| — | Primary | Hb(A, fail, A) | Secondary | — | Secondary | — |
| — | Secondary | — | Primary | Assert(A, B) | Secondary | — |
| — | Secondary | — | Primary | — | Secondary | — |
| — | Secondary | — | Primary | Hb(A, ok, B) | Secondary | — |
| — | Secondary | — | Primary | — | Secondary | — |
| — | Secondary | — | Primary | Hb(A, ok, B) | Secondary | — |
| — | Secondary | — | Dead | — | Secondary | — |
| — | Secondary | — | Dead | — | Secondary | Hb |
| | | | | | | time_out |
| — | Secondary | — | Dead | — | Primary | Assert(A, C) |
| — | Secondary | — | Dead | — | Primary | — |
| — | Secondary | — | Dead | — | Primary | Hb(A, ok, C) |
| — | Secondary | — | Dead | — | Primary | — |
| — | Secondary | — | Dead | — | Primary | Hb(A, ok, C) |

As shown in Table 1, the rows represent the current state and action taken by ASD A, ASD B and ASD C, over time. At time 0, all the ASDs have an initial no_failover state, and each reset their time-out monitoring periods. At time 1-3, the host controller (e.g., remote management console, firmware or local configuration interface), issues a series of configuration messages over the SMBus. ASD A receives a configuration message and configures itself to operate in primary mode at time 1. ASD B receives a configuration message and configures itself to operate in a secondary mode at time 2. ASD C receives a configuration message and configures itself to operate in a secondary mode at time 3. At time 5, ASD A begins sending a status message as the primary ASD over the SMBus. This continues at times 7 and 9 using a well-known period of time. The status message sent at time 9 indicates that the primary ASD is entering a failed state. At time 10, ASD B masters the cycle and sends a failover assert message indicating that it is now taking over as the primary ASD. At times 12 and 14, ASD B sends a status message over the SMBus as the new primary ASD. At time 15, ASD B enters a failed state and stops sending the status messages. ASD C monitors the SMBus, and detects that a status message has not been received within the designated time out period at time 16. At time 17, ASD C masters the cycle and sends a failover assert message indicating that it is now taking over as the primary ASD. ASD C begins sending status messages as the new primary ASD.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to perform failover, comprising:
monitoring a sensor by a first alert sending device;
monitoring said first alert sending device by a second alert sending device;
determining whether said first alert sending device is in a failed state; and
monitoring said sensor by a second alert sending device in accordance with said determination.

2. The method of claim 1, wherein monitoring said sensor by said first alert sending device comprises:
detecting said sensor is in a failed state by said first alert sending device; and
sending an alert message over a first network interface corresponding to said first alert sending device to indicate said failed state.

3. The method of claim 1, further comprising:
detecting said sensor is in a failed state by said second alert sending device; and
sending an alert message over a second network interface corresponding to said second alert sending device to indicate said failed state.

4. The method of claim 1, wherein monitoring said first alert sending device comprises:
sending a status message on a periodic basis over a bus from said first alert sending device; and
receiving said status message at said second alert sending device from said bus.

5. The method of claim 4, wherein said determining comprises:
retrieving a failover status identifier from said status message; and
detecting said first alert sending device is in said failed state in accordance with said failover status identifier.

6. The method of claim 4, wherein said determining comprises:
monitoring said bus for said period;
determining whether said status message was received within said period; and
detecting said first alert sending device is in said failed state if said status message was not received within said period.

7. A method to perform failover, comprising:
determining that a first alert sending device is to operate in a primary mode;
sending a status message on a periodic basis over a bus to indicate said first alert sending device is in an operating state;
detecting that said first alert sending device is in a failed state; and
sending said status message to indicate said first alert sending device is in said failed state.

8. The method of claim 7, further comprising monitoring a sensor by said first alert sending device.

9. The method of claim 7, wherein said status message comprises fields for a teamed address, a failover status and an alert sending device address for said first alert sending device.

10. The method of claim 7, further comprising receiving a configuration message to configure said first alert sending device in said primary mode.

11. The method of claim 7, wherein said configuration message comprises fields for an alert sending device address for said first alert sending device, a failover configuration, and a teamed address.

12. A method to perform failover, comprising:
determining that a second alert sending device is to operate in a secondary mode;
receiving a status message on a periodic basis over a bus to indicate a first alert sending device is in an operating state;
detecting that said first alert sending device is in a failed state; and
sending a failover assert message to indicate that said second alert sending device is to operate in a primary mode.

13. The method of claim 12, wherein said detecting comprises:
receiving said status message;
retrieving a failover status identifier from said status message; and
detecting said first alert sending device is in said failed state in accordance with said failover status identifier.

14. The method of claim 12, wherein said detecting comprises:
monitoring said bus for said period;
determining whether said status message was received within said period; and
detecting said first alert sending device is in said failed state if said status message was not received within said period.

15. The method of claim 12, further comprising receiving a configuration message to configure said second alert sending device in said secondary mode.

16. The method of claim 12, wherein said failover assert message comprises fields for a teamed address and an alert sending device address for said second alert sending device.

17. An alert system, comprising:
a sensor;
a bus to connect with said sensor;
a first alert sending device to connect to said bus and monitor said sensor; and
a second alert sending device to connect to said bus and monitor said first alert sending device.

18. The alert system of claim 17, wherein said first alert sending device comprises:
a bus interface to interface with said bus;
an alert module to connect to said bus interface, said alert module to monitor said sensor and generate an alert if said sensor is in a failed state;
a network interface to connect to said alert module to send said alert; and
a failover module to connect to said bus interface.

19. The alert system of claim 18, wherein said failover module is configured to have said first alert sending device operate in a primary mode, and send periodic status messages over said bus to said second alert sending device.

20. The alert system of claim 17, wherein said second alert sending device comprises:
a bus interface to interface with said bus;
an alert module to connect to said bus interface, said alert module to monitor said sensor and generate an alert if said sensor is in a failed state;
a network interface to connect to said alert module to send said alert; and
a failover module to connect to said bus interface.

21. The alert system of claim 20, wherein said failover module is configured to have said second alert sending device operate in a secondary mode, detect whether said first alert sending device is in a failed state, and change to a primary mode if said failed state is detected.

22. An alert sending device, comprising:
a bus interface to interface with a bus;
an alert module to connect to said bus interface, said alert module to monitor a sensor and generate an alert if said sensor is in a failed state;
a network interface to connect to said alert module to send said alert; and
a failover module to connect to said bus interface.

23. The alert sending device of claim 22, wherein said failover module is configured to have said alert sending device operate in a primary mode, and send periodic status messages over said bus.

24. The alert sending device of claim 22, wherein said failover module is configured to have said alert sending device operate in a secondary mode, detect whether another alert sending device is in a failed state, and change to a primary mode if said failed state is detected.

25. The alert sending device of claim 22, wherein said bus comprises a system management bus.

26. An article comprising:
a storage medium;
said storage medium including stored instructions that, when executed by a processor, result in performing failover by monitoring a sensor by a first alert sending device, monitoring said first alert sending device by a second alert sending device, determining whether said first alert sending device is in a failed state, and monitoring said sensor by a second alert sending device in accordance with said determination.

27. The article of claim 26, wherein the stored instructions, when executed by a processor, further result in said monitoring said sensor by said first alert sending device by detecting said sensor is in a failed state by said first alert sending device, and sending an alert message over a first network interface corresponding to said first alert sending device to indicate said failed state.

28. The article of claim 27, wherein the stored instructions, when executed by a processor, further result in said failover by detecting said sensor is in a failed state by said second alert sending device, and sending an alert message over a second network interface corresponding to said second alert sending device to indicate said failed state.
